(19) United States
(12) Patent Application Publication
(10) Pub. No.: US 2013/0084004 A1
(43) Pub. Date: Apr. 4, 2013

(54) IMAGE PROCESSING OF DATA FROM SCANNED DISPLAY

(71) Applicants: Kirk Steven Tecu, Longmont, CO (US); Mabry Frazier Dozier, Lafayette, CO (US)

(72) Inventors: Kirk Steven Tecu, Longmont, CO (US); Mabry Frazier Dozier, Lafayette, CO (US)

(73) Assignee: KONICA MINOLTA LABORATORY U.S.A., INC., San Mateo, CA (US)

(21) Appl. No.: 13/249,749

(22) Filed: Sep. 30, 2011

(51) Int. Cl. G06K 9/00; G06K 9/40

(52) U.S. Cl. 382/167; 382/260; 382/255

(57) ABSTRACT

A method for image processing a two-dimensional (2D) code, including: obtaining an image by scanning a screen displaying the 2D code using a plurality of pixels, where the image includes multiple hard edges corresponding multiple spaces on the screen between the multiple pixels; identifying a pixel pitch of the screen; reducing the multiple hard edges by applying a filter based on the pixel pitch to the image; and generating, after reducing the multiple hard edges, a binary image including the 2D code by applying a threshold function to the image.

### BACKGROUND

Two dimensional (2D) codes, such as quick response (QR) codes, have become a popular means of relaying information across a variety of industries. A 2D code consists of black and/or color pixels arranged in a square pattern on a white background. 2D codes serve to encode information, which may be made up of various types of data (e.g. binary, alphanumeric, Kanji symbols, Uniform Resource Locators, metadata, instructions to send a text message, instructions to compose an email, instructions to add a contact to a mobile device). 2D codes are often used to relay information to customers of a business.

Scanners are used to generate electronic versions of various types of media. For example, scanners are typically used to scan paper, photographs, and in some cases, backlit screens displaying 2D codes. However, the image obtained by a scanner from scanning a backlit display may be less than desirable for submission as input to a 2D decoding process. Regardless, users still capture 2D codes by scanning screens displaying the 2D codes.

### SUMMARY

In general, in one aspect, the invention relates to a method for image processing a two-dimensional (2D) code. The method comprises: obtaining an image by scanning a screen displaying the 2D code using a plurality of pixels, wherein the image comprises a plurality of hard edges corresponding to a plurality of spaces on the screen between the plurality of pixels; identifying a pixel pitch of the screen; reducing the plurality of hard edges by applying a filter based on the pixel pitch to the image; and generating, after reducing the plurality of hard edges, a binary image comprising the 2D code by applying a threshold function to the image.

In general, in one aspect, the invention relates to a non-transitory computer readable storage medium storing a plurality of instructions for image processing a two-dimensional (2D) code. The instructions comprise functionality for: obtaining an image by scanning a screen displaying the 2D code using a plurality of pixels, wherein the image comprises a plurality of hard edges corresponding to a plurality of spaces on the screen between the plurality of pixels; identifying a pixel pitch of the screen; reducing the plurality of hard edges by applying a filter based on the pixel pitch to the image; and generating, after reducing the plurality of hard edges, a binary image comprising the 2D code by applying a threshold function to the image.

In general, in one aspect, the invention relates to a system for image processing a two-dimensional (2D) code. The system comprises: a scanner configured to scan a screen displaying the 2D code using a plurality of pixels, wherein the image comprises a plurality of hard edges corresponding to a plurality of spaces on the screen between the plurality of pixels; a pitch engine configured to identify a pixel pitch of the screen; a filter engine operatively connected to the pitch engine and configured to reduce the plurality of hard edges by applying a filter to the image based on the pixel pitch; and a binary convertor operatively connected to the filter engine and configured to generate a binary image by applying a threshold function to the image.

Other aspects of the invention will be apparent from the following description and the appended claims.

### BRIEF DESCRIPTION OF DRAWINGS

FIG. 1 shows a system in accordance with one or more embodiments of the invention.

FIG. 2 shows a flowchart in accordance with one or more embodiments of the invention.

FIGS. 3A and 3B show an example in accordance with one or more embodiments of the invention.

FIG. 4 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a system and method for generating a binary image. Specifically, a screen displaying a 2D code may be scanned to generate an electronic image. The image may be processed using various functions and mathematical transformations, and a binary image with a 2D code suitable for decoding may be generated.

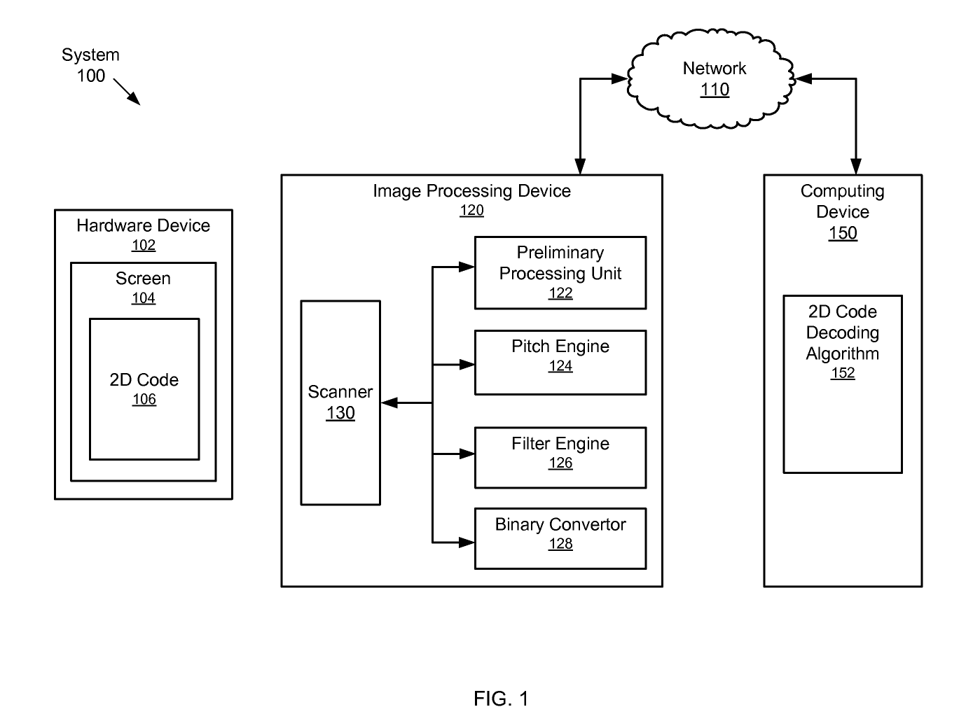

FIG. 1 shows a system (100) in accordance with one or more embodiments of the invention. As shown in FIG. 1, the system (100) includes components such as a hardware device (102), an image processing device (120), and a computing device (150). These components are described below and two or more of these components may be located on the same device (e.g. a server, mainframe, desktop Personal Computer (PC), laptop, Personal Digital Assistant (PDA), telephone, mobile phone, kiosk, cable box, multifunction printer (MFP), and any other hardware device) or may be located on separate devices connected by a network (e.g., the Internet, a wide area network (WAN), or a local area network (LAN)), with wired and/or wireless segments. In one or more embodiments of the invention, there may be more than one image processing device, as well as more than one hardware device in system (100).

In one or more embodiments of the invention, the hardware device (102) is a mobile device such as a smart phone, a PDA, a tablet, an e-reader, a laptop computer, etc. As shown in FIG. 1, the hardware device (102) includes a screen (104) for displaying items (e.g., text, images, photographs, video clips, animation, 2D codes, etc.) retrieved and/or generated by the hardware device (102). Specifically, the screen (104) includes multiple pixels that can be individually activated (i.e., illuminated) and deactivated to effectively display the items. Although pixels are placed in close proximity to each other, gaps (i.e., spaces) still exist between adjacent pixels. The screen (104) may be a backlit liquid crystal display (LCD). Further, the screen (104) may be a touchscreen (i.e. responsive to tactile input) and thus used by the hardware device (102) to receive input from a user.

In one or more embodiments of the invention, the hardware device (102) displays 2D codes (e.g., 2D code (106)) on the screen (104). The 2D code (106) may be displayed in response to a user request. As discussed above, the 2D code (106) may consists of black and/or color pixels arranged in a square pattern on a white background. Moreover, the 2D code may encode one or more data items (e.g., a URL).

In one or more embodiments of the invention, the image processing device (120) is configured to process 2D codes. As shown in FIG. 1, the image processing device (120) includes a scanner (130), a preliminary processing unit (122), a pitch engine (124), a filter engine (126), and a binary convertor (128). Each engine and/or component of the image processing device (120) is described below. Those skilled in the art will appreciate that each of the engines and components described may have other functionality beyond that disclosed, and that the functionality of each engine and/or component may alternatively be performed by any of the other components. After processing a 2D code, the image processing device (120) may transmit the 2D barcode to a computing device (150) through a network (110).

In one or more embodiments of the invention, the scanner (130) is configured to scan the 2D code (106) displayed on the screen (104) of the hardware device (102). Accordingly, the scanner (130) is configured to generate an image having the 2D code (106) by scanning the screen (104) while the 2D code (106) is being displayed. It may be necessary for a user to press/hold the hardware device (102) against the scanner (130) during the scanning process in order to correctly generate the image. Moreover, it may be necessary for the scanner (130) to scan at a resolution that is at least twice the resolution of the screen (104) in order to correctly generate the image (i.e., satisfying the Nyquist sampling limit). Those skilled in the art, having the benefit of this detailed description, will appreciate that the gaps (i.e., spaces) between the pixels on the screen (104) will appear as hard (i.e., dark) edges in the image captured by the scanner (130).

In one or more embodiments of the invention, the preliminary processing unit (122) is configured to apply mathematical transformations on the image (including the 2D code) acquired by the scanner (130). Example transformations include affine transformations (e.g., rotating, skewing) to arrange the captured pixels of the 2D code vertically/horizontally in a grid, and/or grayscale transformations to convert the color image to various shades of black and white. After obtaining the 2D barcode (106) and applying a transformation on the image, the preliminary processing unit (122) may process (i.e. modify, transform, format) the transformed image, and then transmit the transformed image to the pitch engine (124) for further processing. In parallel, the preliminary processing unit (122) may pass control of the system (100) to any other component of the image processing device (120). Those skilled in the art will appreciate that the preliminary processing unit (122) may receive a 2D code from other entities beyond the scanner (130), and may perform other functions beyond those disclosed.

In one or more embodiments of the invention, the pitch engine (124) is configured to identify a pixel pitch of the screen (104) from the image acquired by the scanner (130). The pixel pitch may correspond to the distance between the black or white pixels of the 2D code in the image. In one or more embodiments of the invention, the pixel pitch may be determined by calculating a 2D Fourier transform of the image. The dominant spatial frequency in the Fourier transform is related to 1/(pixel pitch) of the screen (104). The 2D Fourier transform may also include a higher (but not dominant) spatial frequency related to the hard edges in the image (i.e., gaps/spaces between adjacent pixels of the screen (104)).

Those skilled in the art, having the benefit of this detailed description, will appreciate that calculating the 2D Fourier transform is computationally expensive. In alternate embodiments of the invention, a lookup table storing the pixel pitches of various hardware devices, including the hardware device (102), may exist. In such embodiments, the image processing device (120) may prompt the user to identify the hardware device (102), and the pixel pitch engine (124) may then retrieve the pixel pitch of the hardware device (102) from the lookup table, avoiding the need to calculate the 2D Fourier transform.

In one or more embodiments of the invention, the filter engine (126) is configured to reduce the hard edges of the 2D code in the image acquired by the scanner (130). Specifically, the filter engine (126) is configured to apply a filter to the image based on the pixel pitch. In one or more embodiments of the invention, the filter is a Gaussian blur having a standard deviation based on the pixel pitch. For example, the standard deviation may be set to one-half or one-third of the pixel pitch. Following application of the filter, the hard edges between and/or bordering white pixels may appear as grey. Those skilled in the art, having the benefit of this detailed description, will appreciate that various filters may be used to reduce the hard edges.

In one or more embodiments of the invention, the binary convertor (128) is configured to generate a binary image by applying a threshold function to the image. In other words, the threshold function maps, based on a threshold, every area in the grayscale image including the 2D code to black or white, effectively creating a binary image. Following application of the threshold function, the now-grey hard edges between white pixels may be set to white. Those skilled in the art will appreciate that there may be alternative means by which to generate a binary image than those disclosed. After generating a binary image, the binary convertor (128) may process (i.e. modify, transform, format) the binary image, and then transmit the binary image to the computing device (150) for decoding. Those skilled in the art will appreciate that the binary convertor (128) may perform other functions beyond those disclosed.

In one or more embodiments of the invention, the computing device (150) is any type of computer hardware (e.g., a desktop, a server, cloud based computing system, a mainframe, a mobile device, etc.) operatively connected to the image processing device (120) using the network (110). In one or more embodiments of the invention, the computing device (150) is part of the image processing device (120). As shown in FIG. 1, the computing device (150) executes a 2D code decoding algorithm (152). The 2D code decoding algorithm (152) is a software application with functionality to extract one or more data items (e.g., a URL) encoded within a 2D code (e.g., the 2D code in the binary image). For example, the 2D code decoding algorithm (152) may be a QR code decoding algorithm configured to extract one or more data items from a QR code. Those skilled in the art will appreciate that the computing device (150) and the 2D code decoding algorithm (152) may perform other functions beyond those disclosed.

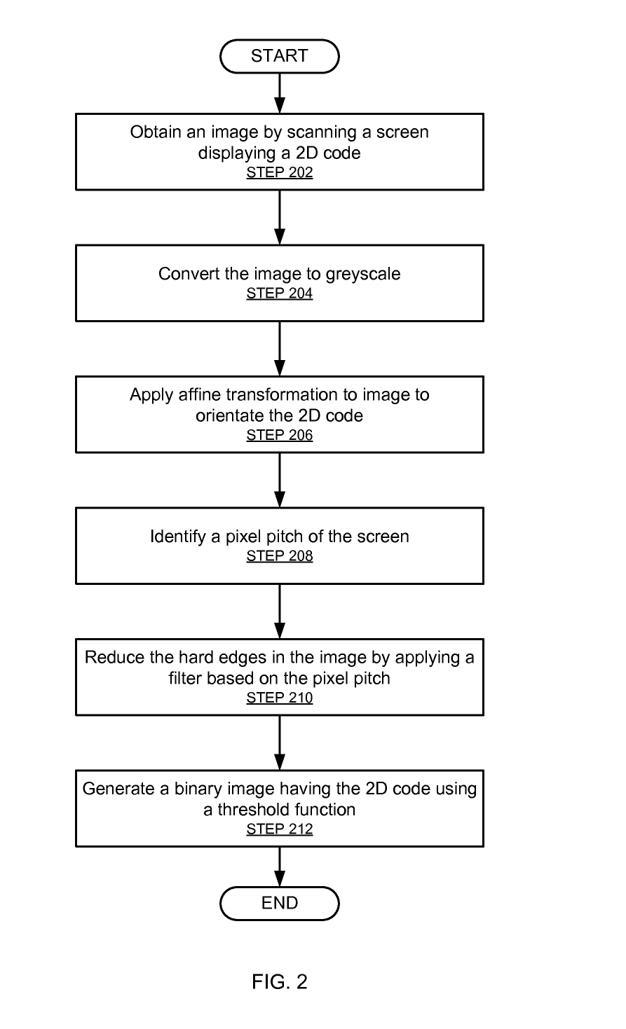

FIG. 2 shows a flowchart in accordance with one or more embodiments of the invention. The process shown in FIG. 2 may be used, for example, with the components of system (100), for image processing a 2D code. One or more steps shown in FIG. 2 may be omitted, repeated, and/or performed in a different order among different embodiments of the invention. Accordingly, embodiments of the invention should not be considered limited to the specific number and arrangement of steps shown in FIG. 2.

Initially, an image of a 2D code is obtained by scanning a screen displaying the 2D code (STEP 202). For example, the screen may be the screen of a smart phone and the 2D code may be a QR code. Further, the scanning may be executed by a scanner of a MFP. In one or more embodiments of the invention, in order to correctly generate the image from the actively illuminated media (i.e. the screen), the scanner must scan at a high enough resolution to adequately capture the fine details of the media. For example, if a binary QR code is being displayed, the scanner must scan at the same or higher resolution of the finest detail of the QR code (i.e. a native QR code “pixel”). In order for the scanner to have sufficient fidelity, the 2D code must be spatially oversampled to ensure adequate capturing of the pixels.

In STEP 204, the image is converted to grayscale. Specifically, as the image is obtained by oversampling the screen, the red, green, and blue (RGB) components that constitute 1 pixel of the screen may be visible in the image. These components may complicate decoding of the 2D code in the image. In one or more embodiments of the invention, the image is converted to grayscale by considering only the green component/channel of the image.

In STEP 206, an affine transformation is applied to the image to properly orientate the 2D code in the image. In other words, the image is de-skewed so that the pixels are properly oriented and arranged vertically/horizontally in a grid. Poor orientation may complicate decoding of the 2D code in the image.

In STEP 208, the pixel pitch of the screen is identified. In one or more embodiments of the invention, the pixel pitch of the screen is identified by calculating the 2D Fourier transform of the image and identifying the dominant spatial frequency. The dominant spatial frequency is related to 1/(pixel pitch) of the screen. Alternatively, the pixel pitch of the screen may be identified by searching a lookup table recording the pixel pitches of various screens. In such embodiments, the user may need to specify the make/model of the hardware device with the screen in order to retrieve the correct pixel pitch from the lookup table. As an example, an LCD screen with a display resolution of 1280 pixels×800 pixels (also known as WXGA) may have a pixel pitch of 204 μm

In STEP 210, hard edges in the image are reduced. As discussed above, the hard edges correspond to the spaces (i.e., gaps) between adjacent pixels in the screen. Moreover, the hard edges in the image may be reduced using a filter having parameters set based on the pixel pitch. For example, the filter may be Gaussian blur (also known as Gaussian smoothing) having a standard deviation of one-half the pixel pitch or one-third the pixel pitch. Those skilled in the art, having the benefit of this detailed description, will appreciate that the hard edges are reduced to prevent the 2D code decoding algorithm from incorrectly determining the hard edges are black pixels. Moreover, following application of the filter, the hard edges between or bordering white pixels appear grey instead of black.

In STEP 212, a binary image is generated. Specifically, the binary image is generated using a threshold function. The threshold function maps each region in the grayscale image to either black or white, effectively creating the binary image. Assuming a proper threshold is selected, the hard edges between the white pixels are mapped to white. Once the binary image is created, the image with the 2D code may be submitted to a 2D code decoder algorithm to extract the one or more data items encoded in the 2D code.

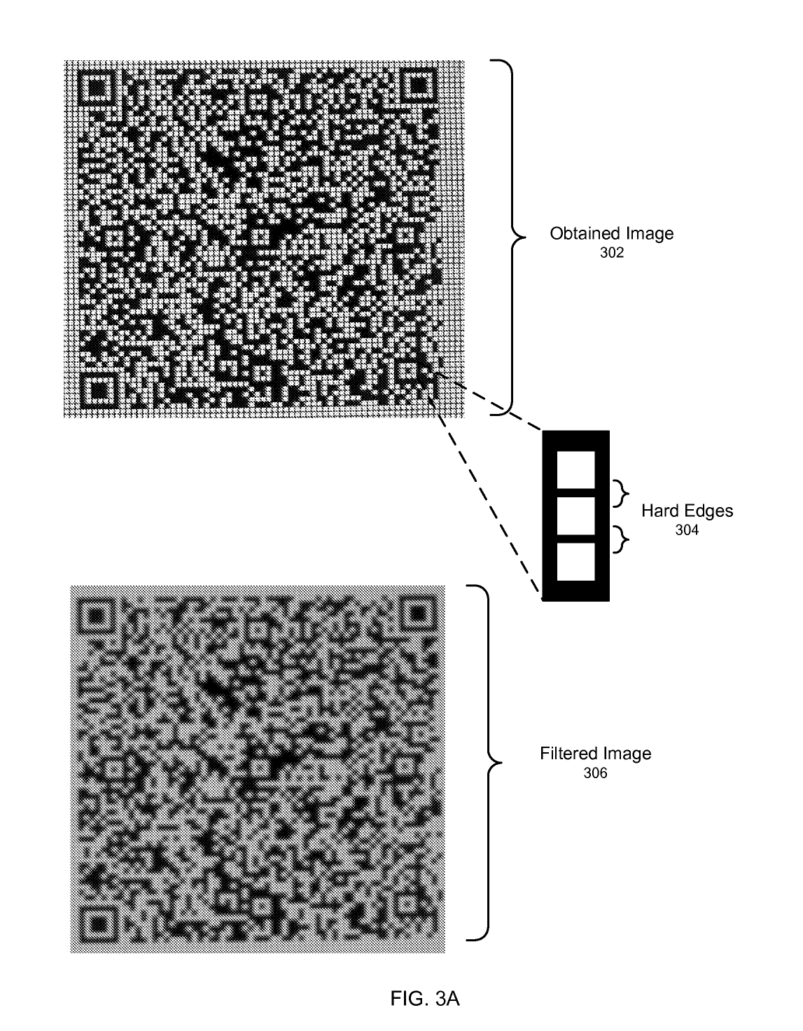

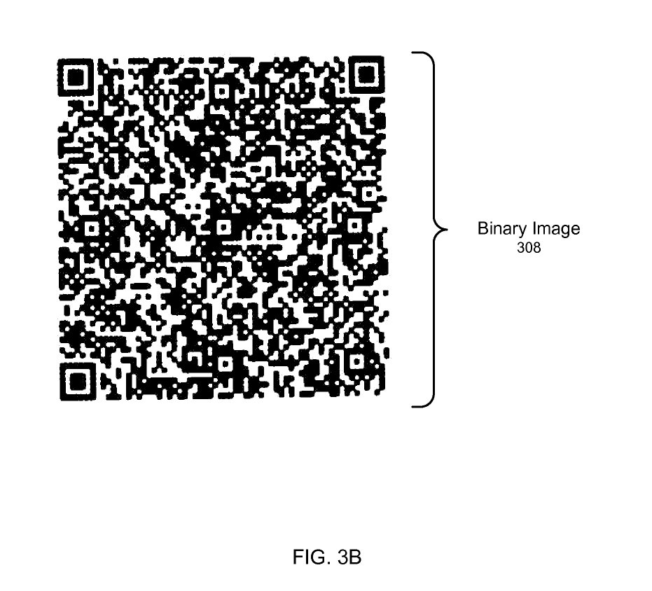

FIG. 3A and FIG. 3B show examples in accordance with one or more embodiments of the invention. Specifically, FIG. 3A shows an obtained image (302) following grayscale conversion and the application of one or more affine transformations to properly orient the 2D code in the image (302). In other words, the image (302) was obtained by first scanning a screen displaying a 2D code, and then performing some preliminary image processing (i.e., affine transformations, grayscale conversion) on the image. As also shown in FIG. 3A, there exists hard edges (304) between and/or bordering the white pixels of the obtained image (302). The hard edges (304) correspond to the spaces (i.e., gaps) between adjacent pixels in the screen.

Once the pixel pitch of the screen is identified (e.g., by calculating the 2D Fourier transform of the obtained image (302) and identifying the dominant spatial frequency), a Gaussian blur having a standard deviation of one-third the pixel pitch is applied to the original image (302), resulting in filtered image (306). As shown in FIG. 3A, the hard edges between and/or bordering the white pixels are reduced and now appear more grey instead of black in the filtered image (306).

FIG. 3B shows a binary image (308) created by applying a threshold function to the filtered image (306). Specifically, the reduced hard edges in the filtered image (306) are mapped to white. Essentially, the threshold function reduces the higher “resolution” of the filtered image (306) to a lower “resolution” of the binary image (308) so that it is more easily decodable by a 2D barcode reader.

Embodiments of the invention may have one or more of the following advantages: the ability to capture a 2D code displayed on a screen (e.g., LCD screen); the ability to refine an image of a 2D code prior to submitting the image to a decoding algorithm; etc.

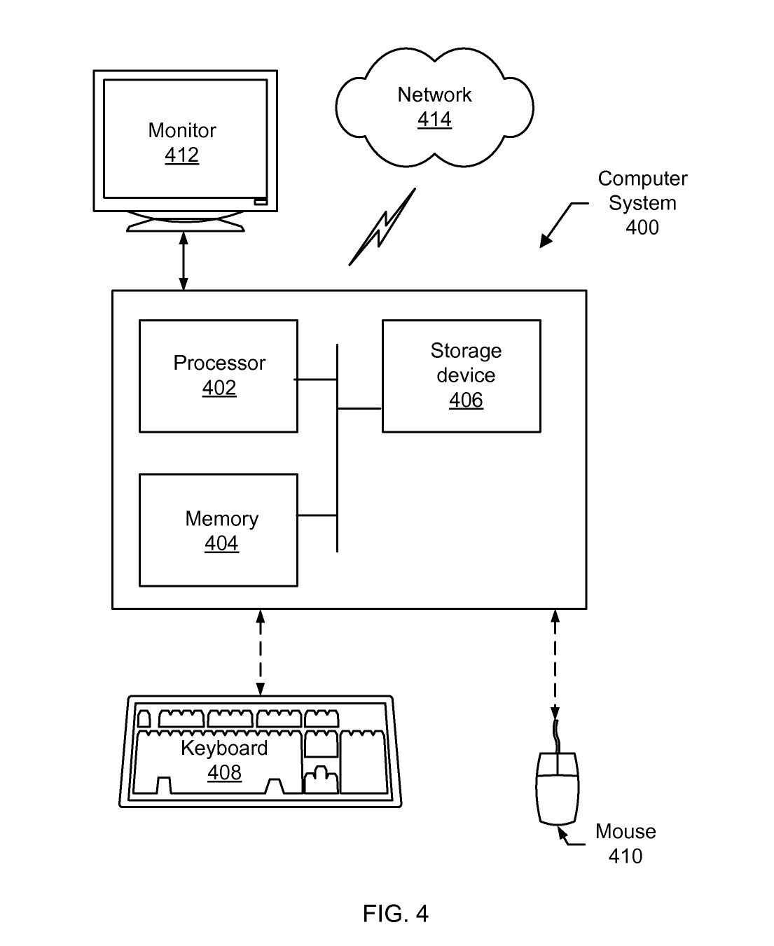

Embodiments of the invention may be implemented on virtually any type of computer regardless of the platform being used. For example, as shown in FIG. 4, a computer system (400) includes one or more processor(s) (402), an associated memory (404) (e.g. random access memory (RAM), cache memory, flash memory, etc.), a storage device (406) (e.g. a hard disk, an optical drive such as a compact disk drive or digital video disk (DVD) drive, a flash memory stick, etc.), and numerous other elements and functionalities typical of today's computers (not shown). In one or more embodiments of the invention, the processor (402) is hardware. For example, the processor may be an integrated circuit. The computer system (400) may also include input means, such as a keyboard (408), a mouse (410), or a microphone (not shown). Further, the computer system (400) may include output means, such as a monitor (412) (e.g. a liquid crystal display (LCD), a plasma display, or cathode ray tube (CRT) monitor). The computer system (400) may be connected to a network (414) (e.g. a local area network (LAN), a wide area network (WAN) such as the Internet, or any other type of network) via a network interface connection (not shown). In one or more embodiments of the invention, many different types of computer systems exist, and the aforementioned input and output means may take other forms. Generally speaking, the computer system (400) includes at least the minimal processing, input, and/or output means necessary to practice embodiments of the invention.

Further, in one or more embodiments of the invention, one or more elements of the aforementioned computer system (400) may be located at a remote location and connected to the other elements over a network. Further, embodiments of the invention may be implemented on a distributed system having a plurality of nodes, where each portion of the invention (e.g. the hardware device, the image processing device, the computing device) may be located on a different node within the distributed system. In one embodiment of the invention, the node corresponds to a computer system. Alternatively, the node may correspond to a processor with associated physical memory. The node may alternatively correspond to a processor or micro-core of a processor with shared memory and/or resources. Further, software instructions in the form of computer readable program code to perform embodiments of the invention may be stored, temporarily or permanently, on a non-transitory computer readable storage medium, such as a compact disc (CD), a diskette, a tape, memory, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for image processing a two-dimensional (2D) code, comprising:
obtaining an image by scanning a screen displaying the 2D code using a plurality of pixels, wherein the image comprises a plurality of hard edges corresponding to a plurality of spaces on the screen between the plurality of pixels;
identifying a pixel pitch of the screen;
reducing the plurality of hard edges by applying a filter based on the pixel pitch to the image; and
generating, after reducing the plurality of hard edges, a binary image comprising the 2D code by applying a threshold function to the image.

2. The method of claim 1, further comprising:
applying an affine transformation to the image comprising the 2D code to orientate the 2D code.

3. The method of claim 1, further comprising:
converting the image to grayscale.

4. The method of claim 1, wherein identifying the pixel pitch comprises:
obtaining an identity of a hardware device comprising the screen; and
inputting the identity to a lookup table recording a plurality of pixel pitches for a plurality of hardware devices.

5. The method of claim 1, wherein identifying the pixel pitch comprises:
calculating a Fourier transform of the image; and
identifying a dominant spatial frequency from the Fourier transform.

6. The method of claim 1, wherein the filter is a Gaussian blur having a standard deviation based on the pixel pitch.

7. The method of claim 1, further comprising:
submitting the binary image to a decoding algorithm,
wherein the 2D code is a quick response (QR) code, and
wherein the screen is a backlit liquid crystal display (LCD).

8. A non-transitory computer readable storage medium storing a plurality of instructions for image processing a two-dimensional (2D) code, the instructions comprising functionality for:
obtaining an image by scanning a screen displaying the 2D code using a plurality of pixels, wherein the image comprises a plurality of hard edges corresponding to a plurality of spaces on the screen between the plurality of pixels;
identifying a pixel pitch of the screen;
reducing the plurality of hard edges by applying a filter based on the pixel pitch to the image; and
generating, after reducing the plurality of hard edges, a binary image comprising the 2D code by applying a threshold function to the image.

9. The non-transitory computer readable storage medium of claim 8, the instructions further comprising functionality for:
applying an affine transformation to the image comprising the 2D code to orientate the 2D code.

10. The non-transitory computer readable storage medium of claim 8, the instructions further comprising functionality for:
converting the image to grayscale.

11. The non-transitory computer readable storage medium of claim 8, wherein the instructions for identifying the pixel pitch comprise functionality for:
obtaining an identity of a hardware device comprising the screen; and
inputting the identity to a lookup table recording a plurality of pixel pitches for a plurality of hardware devices.

12. The non-transitory computer readable storage medium of claim 8, wherein the instructions for identifying the pixel pitch comprise functionality for:
calculating a Fourier transform of the image; and
identifying a dominant spatial frequency from the Fourier transform.

13. The non-transitory computer readable storage medium of claim 8, wherein the filter is a Gaussian blur having a standard deviation based on the pixel pitch.

14. The non-transitory computer readable storage medium of claim 8, the instructions further comprising functionality for:
submitting the binary image to a decoding algorithm,
wherein the 2D code is a quick response (QR) code, and
wherein the screen is a backlit liquid crystal display (LCD).

15. A system for image processing a two-dimensional (2D) code, comprising:
a scanner configured to scan a screen displaying the 2D code using a plurality of pixels, wherein the image comprises a plurality of hard edges corresponding to a plurality of spaces on the screen between the plurality of pixels;
a pitch engine configured to identify a pixel pitch of the screen;
a filter engine operatively connected to the pitch engine and configured to reduce the plurality of hard edges by applying a filter to the image based on the pixel pitch; and
a binary convertor operatively connected to the filter engine and configured to generate a binary image by applying a threshold function to the image.

16. The system of claim 15, further comprising:
a preliminary processing unit configured to execute at least one selected from a group consisting of applying an affine transformation to the image comprising the 2D code to orientate the 2D code and converting the image to grayscale.

17. The system of claim 15, wherein the pitch engine is configured to calculate a Fourier transform of the image and identify a dominant spatial frequency from the Fourier transform.

18. The system of claim 15, wherein the pitch engine comprises:
a lookup table configured to input an identity of a hardware device comprising the screen and output the pixel pitch based on the identity of the hardware device.

19. The system of claim 15, wherein the filter is a Gaussian blur having a standard deviation based on the pixel pitch.

20. The system of claim 15, wherein the 2D code is a quick response (QR) code, and wherein the screen is a backlit liquid crystal display (LCD).
